(19) United States
(12) Patent Application Publication
(10) Pub. No.: US 2017/0355229 A1
(43) Pub. Date: Dec. 14, 2017

(54) ROLANT FARM ELEMENT

(71) Applicant: OTICO, Chalmaison (FR)

(72) Inventor: Olivier PHELY, Thenisy (FR)

(73) Assignee: OTICO, Chalmaison (FR)

(21) Appl. No.: 15/621,422

(22) Filed: Jun. 13, 2017

(30) Foreign Application Priority Data
Jun. 14, 2016 (FR) 16 55513

(51) Int. Cl. B60C 7/00; B60C 17/04

(52) U.S. Cl. CPC B60C 7/00; B60C 17/041; B60C 17/046; B60C 2007/005

(57) ABSTRACT

An agricultural implement comprises a wheel body with a peripheral groove, a tire with a bead projecting radially inward, and a radial lock which locks the tire around the wheel body. The bead is shaped so as to be housed in the groove when the tire is mounted around the wheel body. The radial lock comprises a first aperture formed in the wheel body, opening into the groove on the one hand and onto a main face of the wheel body on the other hand, at least a second aperture formed in the bead of the tire, opening substantially facing the first aperture, and a pin placed in the first aperture and the second aperture.

The invention relates to an agricultural implement of the type comprising a wheel body and a tire mounted around this wheel body.

The wheel body usually has a rigid structure, made for example of metal or plastic. The tire has a flexible structure designed for cultivating the soil. It is made of elastomer, for example.

In operation, the wheel body and the tire behave very differently from one another. The tire tends to become at least partially separated from the wheel body. The term used for this is “roll-off”. The tire becomes damaged. The implement ceases to be usable.

Radially clamping the tire onto the wheel body is not usually sufficient in itself to prevent roll-off during operation. It is therefore desirable to lock the wheel body and the tire to one another, at least radially.

Such locking is normally provided by interaction of shapes between the tire and the wheel body. The bead of the time, that is to say its radially inner portion is shaped so as to have at least one annular retaining surface oriented radially outward. This surface interacts with a matching annular surface of the wheel body oriented radially inward. These retaining surfaces combine to form a lock which prevents the tire from separating from the wheel body during operation.

The bead commonly has a cross section having a shape resembling that of a mushroom, while the wheel body has a cross section in the shape of hooks on its periphery. Part of the hook surfaces and part of the surfaces of the mushroom shape form retaining surfaces which interact with one another. Other complex cross section shapes may be used.

The complexity of the bead shapes tends to increase the manufacturing costs and time for the wheel body and the tire. It restricts the tread shapes that can be industrially produced.

The invention is intended to improve the situation.

The applicant proposes an agricultural implement comprising:
a wheel body having two main faces and a peripheral groove, opening radially outward, formed between the two main faces,
a tire including a substantially annular outer part and a bead projecting radially inward from the outer part, the bead being shaped so as to be housed in the groove when the tire is mounted around the wheel body, and
a radial lock which locks the tire around the wheel body.

The radial lock comprises:
a first aperture formed in the wheel body, opening into the groove on the one hand, and onto one of the two main faces on the other hand,
at least a second aperture formed in the tire bead, opening substantially facing the first aperture, and
a pin placed in the first aperture and the second aperture.

Such an agricultural implement has better resistance to roll-off than the existing implements, notably those in which the tire has a mushroom-shaped bead. Additionally, the wheel body and the tire of the proposed agricultural implement may be made without any undercut surface, thus facilitating removal from the mold and reducing manufacturing costs. The radial lock configured in this way also provides axial locking and anti-rotation locking to prevent the rotation of the tire relative to the wheel body.

According to other aspects, the applicant proposes a wheel body for an agricultural implement, a tire for an agricultural implement, an agricultural implement kit and a method for manufacturing an agricultural implement.

The wheel body has two main faces and a peripheral groove, opening radially outward, formed between the two main faces. The peripheral groove is shaped so as to receive a tire bead when said tire is mounted around the wheel body. At least a first aperture is formed in the wheel body, opening into the groove on the one hand, and onto one of the two main faces on the other hand.

The tire for an agricultural implement includes a substantially annular outer part and a bead projecting radially inward from the outer part. The bead is shaped so as to be housed in a groove of a wheel body when the tire is mounted around said wheel body. At least one aperture is formed in the bead, opening onto a lateral surface of the bead.

The agricultural implement kit comprises a wheel body and at least one pin. The wheel body has two main faces and a peripheral groove, opening radially outward, formed between the two main faces. The peripheral groove is shaped so as to receive a tire bead when said tire is mounted around the wheel body. At least a first aperture is formed in the wheel body, opening into the groove on the one hand, and onto one of the two main faces on the other hand. The at least one pin is arranged to be inserted into the at least one first aperture in the wheel body from the main face, projecting into the peripheral groove.

The method for manufacturing the agricultural implement may be broken down into the following steps:
a) injection molding the wheel body,
a) removing the wheel body from the mold,
c) placing the tire around the wheel body on at least a part of the circumference of the wheel body, the placing of the tire around the wheel body including the insertion of the bead into the peripheral groove,
d) inserting at least one pin from one of the main faces of the wheel body, through the wheel body, until it projects into the peripheral groove and penetrates at least partially into the bead so as to form a radial lock which locks the tire around the wheel body.

The following characteristics, which may be present individually or in combination with one another, are optional:
The groove of the wheel body has no radially inwardly oriented retaining surface.
An additional aperture is formed in the wheel body, opening into the groove and substantially facing the at least one first aperture.
The additional aperture is a through hole, and also opens onto one of the main faces of the main body.
At least a first aperture and/or the additional aperture in the wheel body is threaded.
The tire bead has no radially outwardly oriented retaining surface.
The at least one pin in the kit comprises at least a threaded portion such that the pin can be fastened to the wheel body by screwing.
In the kit, the wheel body comprises two webs forming, respectively, one and the other of the two main faces in the state in which they are assembled with one another. The pin is arranged so as to keep the two webs assembled with one another.
The kit further comprises at least one tire as defined above.

Other characteristics and advantages of the invention will be apparent from a perusal of the following detailed description and of the attached drawings, in which:

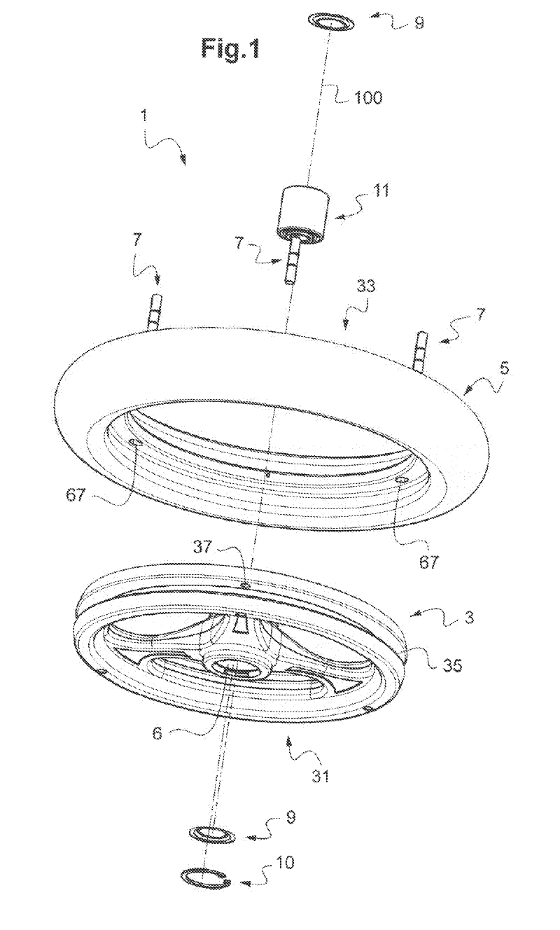

FIG. 1 shows an exploded perspective view of an implement according to the invention,

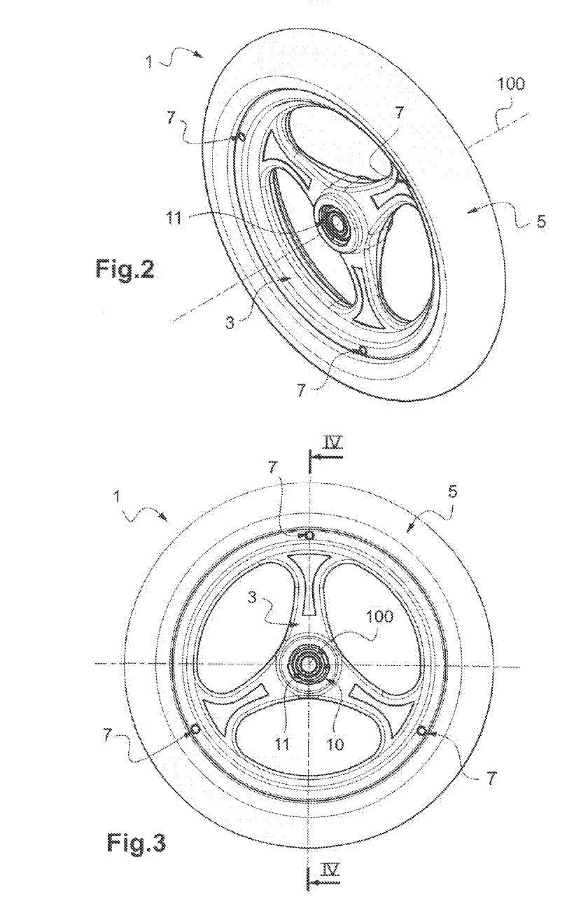

FIG. 2 shows a perspective view of the implement of FIG. 1,

FIG. 3 shows a side view of the implement of FIG. 1,

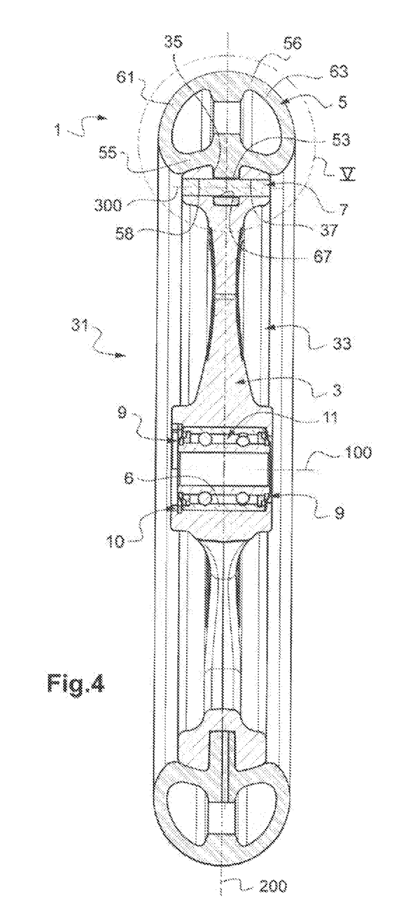

FIG. 4 is a sectional view through the segment IV of FIG. 3,

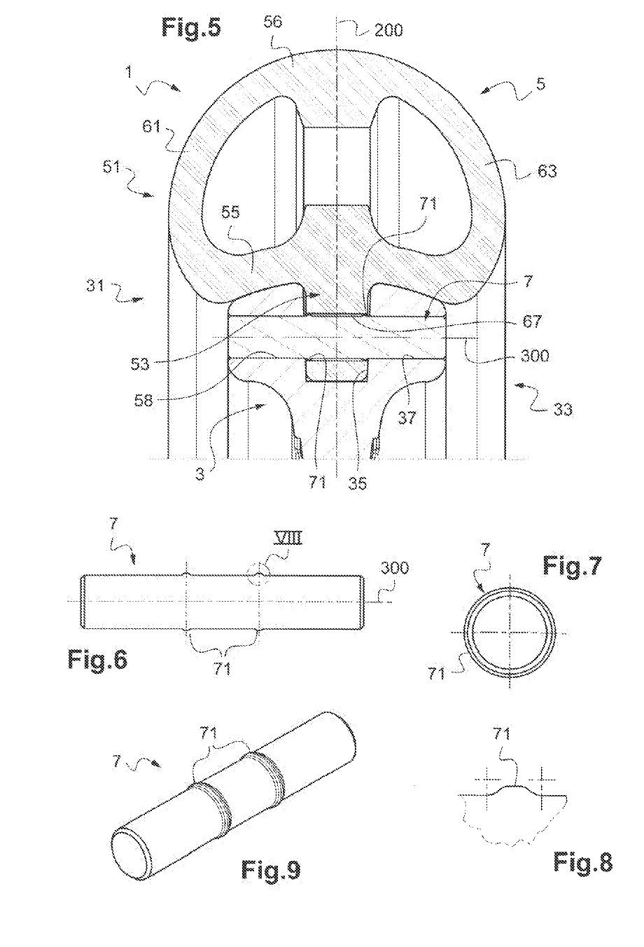

FIG. 5 shows a detail view V of FIG. 4,

FIG. 6 shows a side view of a component of the implement of FIG. 1,

FIG. 7 shows a side view of the component of FIG. 6,

FIG. 8 shows a detail view VIII of FIG. 6,

FIG. 9 shows a perspective view of the component of FIG. 6,

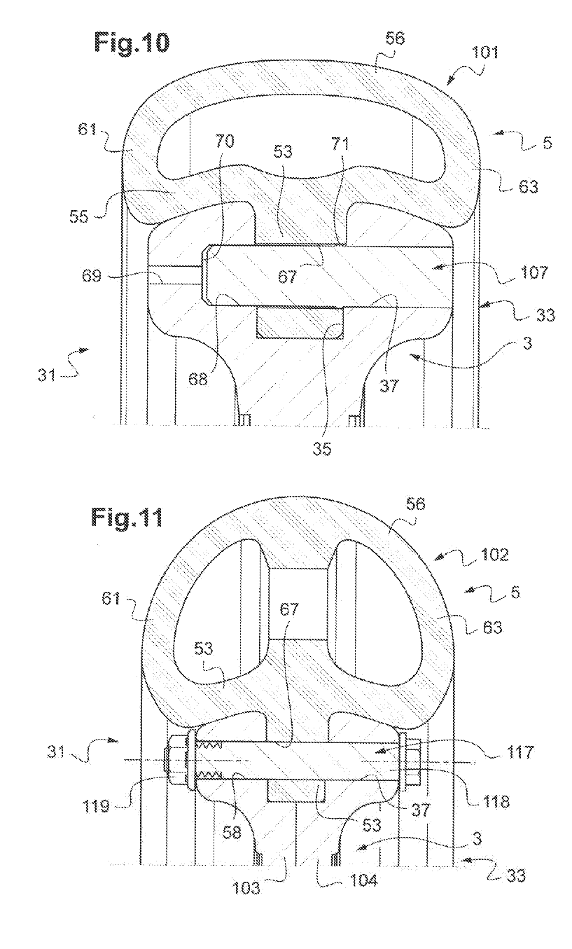

FIGS. 10 to 14 show figures equivalent to FIG. 5 for different implements according to the invention, and

FIGS. 15 and 16 show variant embodiments of an implement according to the invention.

The drawings and description below essentially contain elements of a defined nature. Consequently they can be used not only to clarify the understanding of the present invention but also to contribute to the definition of the invention if necessary.

In FIGS. 2 to 5 and 10 to 14, the implements are shown in the unloaded operational state, that is to say not bearing on the ground.

FIGS. 1 to 5 show an agricultural implement in the form of a wheel 1. The wheel 1 comprises a wheel body 3, a tire 5, pins 7, washers 9, a circlip 10 and a bearing assembly 11.

The wheel 1 has a shape of revolution about an axis of revolution 100, corresponding to the axis of rotation of the wheel 1 when the wheel is mounted on an axle. The wheel 1 has a mid-plane 200 perpendicular to the axis of revolution 100. The mid-plane 200 substantially forms a plane of symmetry of the wheel 1.

The wheel body 3 has two main faces 31 and 33 which are opposed to one another, and a peripheral groove 35. According to the orientation of the wheel 1 in FIG. 4, the first main face 31 here forms a left-hand face, while the second main face 33 here forms a right-hand face. The peripheral groove 35 opens radially outward and is formed between the two main faces 31 and 33. The peripheral groove 35 is shaped so as to receive a bead 53 of the tire 5, which is mounted around the wheel body 3.

The tire 5 comprises an outer part 51, or tire body, which is substantially annular. The bead 53 projects radially inward from the outer part 51. The bead 53 is shaped so as to be housed in the peripheral groove 35 of the wheel body 3.

In the example described here, the wheel body 3 is made in one piece. The tire 5 is mounted on the wheel body 5 by elastically deforming the tire 5 so that the bead 53 can be placed in the peripheral groove 35. The tire 5 is detached from the wheel body in the same way.

In a variant, the wheel body 3 is formed by assembling a plurality of components. For example, the wheel body 3 shown in FIG. 11 is produced by assembling two matching webs 103, 104 on a junction plane which substantially corresponds to the mid-plane 200. Each of the webs 103, 104 forms, respectively, one and the other of the two main faces 31, 33. The webs 103, 104 are held against one another by nut and bolt pairs. In this case, the bead 53 of the tire 5 is positioned between the webs 103, 104 when they are assembled with one another. The production of the wheel body 3 may, for example, comprise cutting out and stamping metal plates or molding plastic components.

Here, the wheel body 3 has an open web and a hub. The web of the wheel may also be solid. The wheel body 3 is formed by molding, using an injection molding process in this case. The wheel body 3 is made of plastic material. The wheel body 3 may be made by other methods and/or made of other materials.

In the example described here, the hub of the wheel body 3 has a bore aligned with the axis of revolution 100. The bore is shaped into a housing 6 receiving the bearing assembly 11. During mounting, the bearing assembly 11 is inserted into the housing 6, between the two washers 9, from the first main face 31 toward the second main face 33 until it is axially stopped. The circlip 10 is then placed in an annular groove of the housing 6 to form an axial stop for the bearing assembly 11 and to oppose its extraction. The bearing assembly 11 has a through opening arranged to be threaded onto an axle of an agricultural machine. The configuration of the housing 6 in the hub and the position of the circlip 10 form exceptions to the symmetrical nature of the wheel 1 about the mid-plane 200. In a variant, the hub may have a different configuration. For example, the wheel body 3 may have no hub. The wheel body may have a wheel web with a substantially open central portion. A hub made as a separate component of the wheel body may be assembled with the wheel web subsequently.

In the example described here, the tire 5 is of the semi-hollow type. The outer part 51 comprises a sole 55, a tread 56 and a pair of sidewalls 61, 63. The sidewalls 61, 63 connect the sole 55 to the tread 56. The sidewalls 61, 63, the sole 55 and the tread 56 jointly form a shell. This shell delimits an inner space. The inner space is generally annular and continuous in the circumference of the tire 5. In this case, an opening, visible in the lower part of FIG. 4, puts the inner space into fluid communication with the outside. Such an opening is, for example, formed by placing a needle through the sole 55 and the bead 53 during the molding of the tire 5. Because of this opening, the tire 5 is neither inflatable not inflated. The non-inflated nature of the tire 5 facilitates deformation during operation, which improves the detachment of any soil that may accumulate on the outer surfaces of the tire 5. In this case, the opening is offset from the mid-plane 200, and forms an exception to the symmetrical nature of the wheel 1 about the mid-plane 200. In a variant, a plurality of openings are provided, and/or the opening is centered in the sole 55.

The tire 5 is made of elastomer, for example rubber or polyurethane. In this case, the tire 5 is made of an elastomer having a Shore A hardness in the range from 40 to 75, for example 65 Shore.

The shape and composition of the outer part 51 of the tire 5 may vary according to the anticipated applications of the agricultural implement, as may be seen, for example, in FIGS. 10 to 14. In a variant, the tire 5 may be inflatable or solid. The inside diameter of the sole 55 of the tire 5 at rest is substantially smaller than the outside diameter of the wheel body 3. When mounted on the wheel body 3, the tire 5 is in a state of stress, being stretched along its circumference. The tire 5 is clamped around the wheel body 3 by elastic return. This improves the resistance to roll-off.

In the examples described here, the shape of the profile of the bead 53, that is to say its contour seen in radial cross section, has no radially outwardly oriented retaining surface. The width of the bead 53, that is to say its dimension in a direction substantially parallel to the axis of revolution 100, decreases or remains constant from the sole 55 to the radially inner end of the bead 53. In the examples shown in the drawings, the width of the bead 53 is equal over its whole height, that is to say along its radial direction. The absence of any undercut facilitates manufacturing.

The peripheral groove 35 of the wheel body 3 has no radial retaining surface, that is to say no radially inwardly oriented surface. This is because any surface whose orientation is at least partially oriented toward the axis of revolution 100 may form a radial retaining surface for the bead 53 of the tire 5. The width of the peripheral groove 35 increases, or is constant as in the examples shown in the drawings, from the bottom of the peripheral groove 35 to its radially outer edge. Because of this configuration of the peripheral groove 35, there is no undercut surface that would complicate removal from the mold. The molding of the wheel body 3, notably by injection molding, and its removal from the mold are facilitated.

The aforesaid shapes of the bead 53 and the groove 35 are distinguished from the known configurations, and notably from those in which the tire bead has a protrusion, Which is mushroom-shaped for example, while the groove of complementary shape Which receives it has a wide bottom and a thin, or constricted, portion. In these known configurations, the constricted portion and the wide bottom are necessarily linked by at least one radially inwardly oriented surface, often in the form of a shoulder, which thus forms a radial retaining surface for the bead. Shapes having no radial retaining surface facilitate the insertion of the bead 53 into the groove 35 and its withdrawal therefrom. Maintenance operations are facilitated. This aspect is particularly advantageous when the tire 5 has to be elastically deformed in order to be mounted around the wheel body 3, for example when the wheel body 3 is made in one piece.

In the case of a one-piece wheel body 3, the absence of a radial retaining surface and therefore of any undercut surface enables the wheel body to be injection molded in one piece without any particular difficulty. A method for manufacturing a wheel body 3 may comprise a single step of injection molding. At the end of the molding step, a one-piece component is formed. The one-piece component bears the two main faces 31 and 33, and has the peripheral groove 35. The one-piece component resulting from the molding substantially corresponds to the final wheel body 3. Optionally, machining and/or finishing operations may take place. There is no need for any additional later step of assembling two components, such as two webs. By comparison, wheel bodies having retaining surfaces in a peripheral groove are difficult to manufacture in one piece by injection molding, unless molds having a number of demountable parts are designed, these molds being particularly complex and costly. This is because the part of the mold thrilling the groove, or core, is trapped by the radial retaining surfaces during removal from the mold.

The agricultural implement has a radial lock which locks the tire 5 around the wheel body 3 in the operational state. The radial lock comprises a pair of apertures 37, 67, or holes, formed in the wheel body 3 and in the tire 5 respectively, and at least one pin 7, or peg, inserted into the pair of apertures 37, 67. In this case, the lock comprises three pairs of apertures 37, 67, and three pins 7, or pegs.

For each pair, a first aperture 37 is formed in the wheel body 3, opening into the peripheral groove 35 on the one hand, and onto one of the two main faces 31, 33 on the other hand. In the examples shown in the drawings, the first aperture 37 is substantially cylindrical and opens onto the second main face 33. A second aperture 67 is formed in the bead 53 of the tire 5. The second aperture 67 has a mouth oriented substantially in the direction of the axis of revolution 100. The second aperture 67 opens on at least one of the two sides of the bead 53. When the tire 5 is mounted around the wheel body 3, the first aperture 37 and the second aperture 67 are positioned substantially in the extension of one another, along the axis 300 shown in FIG. 4. To move to the operational state of the lock, such as that shown in FIGS. 2 to 5, the pin 7, which is bar-shaped in this case, is inserted into the first aperture 37 and the second aperture 67.

In the example of FIGS. 1 to 9, the second aperture 67 is similar to the first aperture 37. It is, for example, formed during the molding of the tire 5. During assembly, the bead 53 is placed in the peripheral groove 35 so that the first aperture 37 and the second aperture 67 of one pair are substantially aligned with one another. The pin 7 can then be introduced into the first aperture 37, in this case from the second main face 33, until it projects into the peripheral groove 35 and is inserted into the second aperture 67 of the bead 53. The radial locking is then operational.

In a variant, the first aperture 37 and the second aperture 67 have different shapes from one another. For example, at least one of the first aperture 37 and the second aperture 67 has a contour whose circumference is oblong, or elongate, in shape, rather than circular, being for example “kidney bean” shaped. Thus the mutually facing positioning of the first aperture 37 and the second aperture 67 is facilitated during the assembly of the tire 5. When the tire 5 is mounted on the wheel body 3, the aim is to bring the first aperture 37 and the second aperture 67 into a facing position, substantially aligned if they have the same shape, so that the pin 7 can be introduced into them. The oblong contour can increase the tolerance on this relative positioning. For example, the oblong contour may extend over an angular sector of more than 5° around the axis of revolution 100.

In FIG. 15, the first aperture 37 of the wheel body 3 is kidney bean-shaped, while the second aperture 67 in the bead 53 has a circular shape. The pin 7 is not shown. In FIG. 16, the first aperture 37 of the wheel body 3 has a circular shape, while the second aperture 67 in the bead 53 has a kidney bean shape, shown in a transparent way by a broken line. The pin 7 is not shown. In this second variant, the elongate shape of the second aperture 67 is invisible and inaccessible in the assembled state of the implement. In addition to the esthetic aspect, this limits the risks of accumulation of dirt, for example soil, during operation. In a third variant, the first aperture 37 of the wheel body 3 and the second aperture 67 in the bead 53 both have an elongate shape in circumference, these shapes being, for example, identical. In this case, the tolerance on the relative positioning is doubled.

In the examples described thus far, the wheel body 3 comprises first apertures 37 whose shapes are similar to one another, being, in particular, circular or elongate in circumference. The tire 5 comprises second apertures 67 whose shapes are similar to one another, being, in particular, circular or elongate in circumference. In a variant, at least one of the first apertures 37 of the wheel body 3 may have a different shape from that of the other first apertures 37 du wheel body 3. At least one of the second apertures 67 of the tire 5 may have a different shape from that of the other second apertures 67 of the wheel body 5. For example, one of the first apertures 37 of the wheel body 3, or one of the second apertures 67 of the tire 5, respectively, may have a substantially circular contour, while the other first apertures 37 of the wheel body 3, or the other second apertures 67 of the tire 5, have a contour lengthened in its circumference. This circular first aperture 37 of the wheel body 3, or this circular second aperture 67 of the tire 5 respectively, may then be referred to as “indexing apertures”, while the elongate apertures may be referred to as “secondary”. This configuration, which is optional, is particularly suitable for two-stage assembly as described below.

A method for manufacturing the agricultural implement may be broken down into the following steps:
a) injection molding a wheel body 3 having two main faces 31, 33 and a peripheral groove 35, opening radially outward, formed between the two main faces 31, 33,
b) removing the wheel body 3 from the mold,
c) placing a tire 5 around the wheel body 3 on at least a part of the circumference of the wheel body 3, said wheel body 3 including a substantially annular outer part 51 and a bead 53 projecting radially inwards from the outer part 51, the placing of the tire 5 around the wheel body 3 including the insertion of the bead 53 into the peripheral groove 35,
d) inserting at least one pin 7 from one of the main faces 31, 33 of the wheel body 3, through the wheel body 3, until it projects into the peripheral groove 35 and penetrates at least partially into the bead 53 so as to form a radial lock which locks the tire 5 around the wheel body 3.

The placing of the tire 5 around the wheel body 3 and the insertion of the bead 53 into the peripheral groove 35 may be carried out completely, that is to say over the whole circumference of the wheel body 3, before a first pin 7 is inserted, followed by the other pins if appropriate. In a variant, the assembly may he carried out in two stages. In this case, the tire 5 is placed around the wheel body 3 on only a part of the circumference of the wheel body 3. The bead 53 is inserted into the peripheral groove 35 on only this part of the circumference. At this stage, the tire 5 remains at rest, and is not clamped elastically around the wheel body 3. The frictional forces between the wheel body 3 and the tire 5 are negligible. The adjustment of the mutually facing positioning of a first aperture 37 of the wheel body 3 and a second aperture 67 of the tire 5 may therefore be performed without effort. The tire 5 is indexed relative to the wheel body 3. When the mutually facing positioning of the first aperture 37 and the second aperture 67 is correct, a first pin 7 may be inserted into them. Thus, the interaction of the first pin 7 and the pair composed of the first aperture 37 and the second aperture 67 forms an anti-rotation lock to prevent rotation of the tire 5 around the wheel body 3. The placing of the tire 5 around the wheel body 3 and the insertion of the bead 53 into the peripheral groove 35 may then be completed on the remaining part of the circumference. The anti-rotation lock limits the risk of involuntary rotation of the tire 5 around the wheel body 3. The pairs composed of the first apertures 37 and second apertures 67 are thus easily brought into a mutually facing position in pairs. The remaining pins 7 may be put into place.

If the wheel body 3 and/or the tire 5 each have apertures with shapes differing from one another, so that they have at least one indexing aperture and some secondary apertures for example, then the indexing apertures may be pinned in a first stage, before the tire is placed around the whole circumference of the wheel body, after which, in the second stage, the secondary apertures are pinned after the tire has been placed around the whole circumference of the wheel body 3. Thus the indexing apertures, of circular shape for example, are easily aligned and then pinned, forming a precise anti-rotation lock, while the secondary apertures, of elongate shape for example, may be pinned even if the facing positioning is only approximate, due to manufacturing inaccuracies or deformation, for example.

In a variant, when the tire 5 is mounted around the wheel body 3, the bead 53 has no second aperture 67. The second aperture 67 is pierced after the tire 5 has been mounted around the wheel body 3, for example by using the first aperture 37 as a guide for piercing. The second aperture 67 may be pierced in a specific operation or, for example, by using a self-drilling and self-tapping screw. Such a screw may form a locking component. In other words, the screw used to pierce the second aperture 67 forms the pin, replacing the substantially cylindrical bar of the embodiment of FIGS. 6 to 9 which is described below.

In the embodiment of FIGS. 1 to 9, an additional aperture 58 is formed in the wheel body 3, opening into the peripheral groove 35 on the one hand, substantially facing the first aperture 37, and onto the other of the two main faces, in this case the first face 31. The first aperture 37 and the additional aperture 58 may be considered as two portions of the same aperture into which the pin 7 is to be inserted. The first aperture 37 and the additional aperture 58 may be formed in the same piercing operation. Such a symmetrical configuration with respect to the mid-plane 200 allows assembly and disassembly from either of the two main faces 31, 33, as desired.

In a variant, the additional aperture 58 is not formed during the manufacture of the wheel body 3, and is absent when the tire 5 is mounted around the wheel body 3. The additional aperture 58 is pierced by using the first aperture 37 as a guide for piercing. The additional aperture 58 may be pierced in a specific operation or, for example, after the piercing of the second aperture 67, by using a self-drilling and self-tapping screw as mentioned above. In this case, the screw is driven into the bead 53 while tapping it. The screw is then driven into the wheel body 3, tapping this in turn, facing the first aperture 37. The screw may be selected to be short, so that the tapping end does not pass through the wheel body 3 from side to side, and the additional aperture 58 remains blind and opens only on the side of the peripheral groove 35.

The pin 7, shown on its own in FIGS. 6 to 9, here takes the form of a substantially cylindrical bar or peg.

The bar comprises two annular ribs 71 projecting from the generally cylindrical surface of the bar. The ribs 71 form local increases in the diameter of the bar. The diameter of the bar and the dimensions of the ribs 71 are arranged to match the diameters of the first aperture 37 and of the additional aperture 58, so that the bar is force-fitted into the apertures. To dislodge the pin 7 and unlock the bead 53, a force is applied to one of the ends of the pin 7, using a tool of the pin punch type, for example. In the locked position, as shown in FIG. 5, the ribs 71 oppose the sliding of the bar.

In a variant, the bar comprises a large-diameter central section located between two small-diameter end sections. In other word, the two ribs 71 are replaced by a continuous section, or central boss, extending axially over a portion equivalent to that delimited between the two ribs 71. This section is arranged to oppose the sliding of the bar in the wheel body 3.

The length of the bar is adapted so that, in the locked position, the opposite ends of the bar lie substantially flush with the first main face 31 and the second main face 33 respectively. In this case, the ends of the bar each have a chamfer. The chamfers may be absent, particularly when it is desirable to reduce the surface roughness of the implement in operation to limit the accumulation of soil and dirt during operation.

In a variant, the bar has one or more sections of decreasing diameter, from the insertion face to the opposite face, from the right to the left in FIG. 4. For example, the pin 7 may have a portion at the insertion end, on the left in the drawings, which is substantially frustoconical. In this way the operation of inserting the pin 7 is facilitated.

In the example described here, the pins 7 are made of plastic, for example polypropylene. The pins 7 may also be made of metallic materials.

In the following embodiments, components similar to those of the embodiment of FIGS. 1 to 9 have identical references.

Reference will now be made to FIG. 10. The implement 101 shown therein is similar to that of the preceding figures, and differs from this in the shape of the outer part 51 of the tire 5 and in a part of the lock, on the left in the drawings. The additional aperture has two portions:
a first portion 68 opening into the peripheral groove 35 and having a diameter substantially equal to that of the first aperture 37, and
a second portion 69, in the alignment of the first portion 68, having a substantially smaller diameter. The two portions 68, 69 are linked to one another by an annular shoulder 70 oriented toward the peripheral groove 35.

The bar forming a pin 107 is shorted relative to that of the preceding figures, so that, when said pin 107 is inserted from the second main face 33, the front end in the direction of insertion, on the left in FIG. 10, abuts against the shoulder 70. The opposite end of the pin 107, on the right in FIG. 10, lies substantially flush with the second main face 33 of the wheel body.

This configuration of the lock prevents the pin 107 from being driven too deeply during mounting. A left-hand rib 71 is superfluous. It is therefore absent, by contrast with the embodiment of the preceding figures. The second portion 69 has a sufficient diameter for the passage of a tool of the pin punch type. The second portion 69 enables the demountable, or unlockable, nature of the assembly to be maintained.

Reference will now be made to FIG. 11. The implement 102 shown therein is similar to that of FIGS. 1 to 5. The implement 102 differs from the latter in having a wheel body formed by the assembly of the two matching webs 103, 104 described above, and in having the pin 117.

In this case, the pin 117 comprises a nut and bolt pair, replacing the bar of FIGS. 1 to 5. The bolt 118 has a hexagonal head, a threaded portion at the opposite end from the head, and an unthreaded portion between the head and the threaded portion. By contrast with the bar-shaped pin 7, the diameter of the bolt 118 is substantially less than the diameters of the apertures into which it is inserted, so that it can be inserted without effort. It is held in place by means of the bolt 119, which is screwed onto the threaded part of the bolt 118, and bears on the main face opposite the head of the bolt 118, which in this case is the first main face 31.

The absence of threading on the portion of the bolt 118 housed in the second aperture 67 of the bead 53 limits the risk of damage to the bore of the second aperture 67, notably due to the effects of shear and abrasion, during the operation of the implement 102.

The nut and bolt pair forms both a radial lock for the tire and a means of clamping the webs 103, 104 against one another. Such a combination is optional. In a variant, a pin in the form of a nut and bolt pair may be used with a one-piece wheel body. The bar-shaped pin 7 may also be used with a body produced by assembling webs.

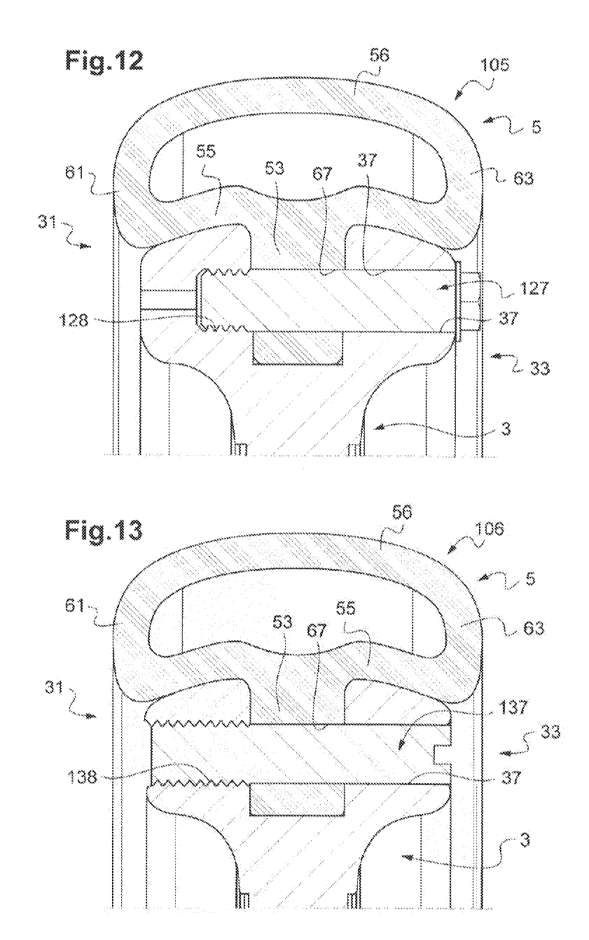

Reference will now be made to FIG. 12. The implement 105 shown therein is similar to that of FIG. 10, and differs from this in having the pin 127 and in having an additional aperture 128, on the left-hand side in the figure.

The additional aperture 128 is blind and opens only into the peripheral groove 35. The pin 127 takes the form of a bolt, in this case having a hexagonal head at one end and a thread on an opposed end portion. The additional aperture 128 has a corresponding female thread.

In a similar way to the bolt 117, the diameter of the bolt 127 is substantially smaller than the diameter of the first aperture 37 in which it is positioned. It is held in place by screwing. The second portion of the bolt 127, which is to be housed in the second aperture 67 of the head 53, has no thread. Remounting is carried out by unscrewing.

Reference will now be made to FIG. 13. The implement 106 shown therein is similar to that of FIG. 12, and differs from this in the absence of a head on the pin 137 and in the additional aperture 138, on the left-hand side in the figure.

The additional aperture 138 is a through hole and opens onto the first main face 31 of the wheel body. The additional aperture 138 is also provided with a female thread extending substantially along its length. The pin 137 takes the form of a bolt similar to the bolt 127, the threaded portion of which is elongated to match the female thread of the additional aperture 138. A screw head pattern, in this case a slot for a flat screwdriver, is formed at the end of the bolt 137 opposed to the threaded end.

The absence of a head enables the pin 137 to be screwed until it lies flush with each of the main faces 31, 33, while remaining easily demountable by screwing or unscrewing.

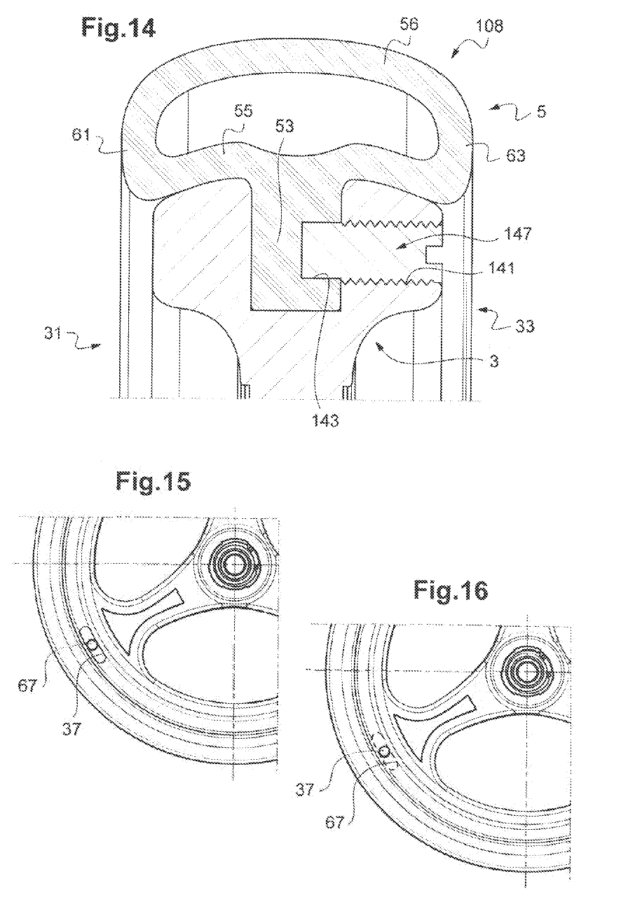

Reference will now be made to FIG. 14. In this embodiment, the first aperture 141 of the implement 101 is provided with a female thread over its whole length. The wheel body has no additional aperture, in the left-hand part in this case. By contrast with the second apertures described thus far, which are through holes, the second aperture 143 in the tire bead is blind and opens substantially facing the first aperture 141. In this case the pin 147 takes the form of a dowel. The pin 147 has a threaded portion that can be screwed into the first aperture 141. The threaded part is extended by an unthreaded portion which is housed in the second aperture 143 in the locked state. In a similar way to the embodiment of FIG. 13, the pin 147 has no head. A screw head pattern is formed in the end which is accessible from the second main face 33 in the locked state.

In the examples described thus far, the first apertures 37, 141 of the wheel body 3 are arranged on a circle having a first diameter centered on an axis of revolution of the wheel body 3, here distributed at equal intervals from one another. The first apertures 37, 141 of the wheel body 3 are three in number. Similarly, the second apertures 67 in the bead 53 of the tire 5 are arranged on a circle having a second diameter, centered on an axis of revolution of the tire 5, here distributed at equal intervals from one another. The second apertures 67 in the bead 53 of the tire 5 are three in number. The inside diameter of the sole 55 of the tire 5 at rest is substantially smaller than the outside diameter of the wheel body 3. At rest, the first diameter is therefore substantially greater than the second diameter. The first apertures 37, 141 and the second apertures 67 are substantially paired. In a variant, the pairs may be present in a number other than three, and/or may be non-equidistant from one another in the circumference.

The embodiments shown, notably in FIGS. 10 to 14, have combinations of characteristics which provide particular benefits. However, and except in cases of evident incompatibility, the characteristics of the embodiments described above can generally be combined with one another.

The implement according to the invention is defined at least partially by the interaction of a plurality of components. These components may be supplied as follows:
assembled with one another to form an implement ready for use,
together, in the demounted state in kit form, or
separately from one another; for example, a tire sold on its own to replace a worn tire on a pre-existing wheel body.

The invention is not limited to the examples of agricultural implements described above solely by way of example, but incorporates all the variants that may be devised by those skilled in the art in the context of the claims below, notably in the form of an implement, a wheel body, a tire or a kit of compatible components.

1. Agricultural implement comprising:
a wheel body having two main faces and a peripheral groove, opening radially outward, formed between the two main faces,
a tire including a substantially annular outer part and a bead projecting radially inward from the outer part, the bead being shaped so as to be housed in the groove when the tire is mounted around the wheel body, and
a radial lock which locks the tire around the wheel body, wherein the radial lock comprises:
a first aperture formed in the wheel body, opening into the peripheral groove on the one hand, and onto one of the two main faces on the other hand,
at least a second aperture formed in the bead of the tire, opening substantially facing the first aperture, and
a pin placed in the first aperture and the second aperture.

2. Wheel body for an agricultural implement having two main faces and a peripheral groove, opening radially outward, formed between the two main faces, the peripheral groove being shaped so as to receive a bead of a tire when said tire is mounted around the wheel body,
wherein at least a first aperture is formed in the wheel body, opening into the peripheral groove on the one hand, and onto one of the two main faces on the other hand.

3. Wheel body according to claim 2, wherein the groove has no radially inwardly oriented retaining surface.

4. Wheel body according to claim 2, wherein an additional aperture is formed in the wheel body, opening into the groove substantially facing the at least one first aperture.

5. Wheel body according to claim 4, wherein the additional aperture is a through hole, and also opens onto one of the main faces.

6. Wheel body according to claim 2, wherein the at least one first aperture and/or the additional aperture is provided with a thread.

7. Tire for an agricultural implement including a substantially annular outer part and a bead projecting radially inward from the outer part, the bead being shaped so as to be housed in a groove of a wheel body when the tire is mounted around said wheel body,
wherein at least one aperture is formed in the bead and opens onto a lateral surface of the bead.

8. Tire according to claim 7, wherein the bead has no radially outwardly oriented retaining surface.

9. Agricultural implement kit comprising:
a wheel body having two main faces and a peripheral groove opening radially outward and formed between the two main faces, the peripheral groove being shaped so as to receive a bead of a tire when said tire is mounted around the wheel both, at least a first aperture being formed in the wheel body and opening into the groove on the one hand, and into one of the two main faces on the other hand, and
at least one pin arranged to be inserted into the at least one first aperture in the wheel body from the main face, projecting into the peripheral groove.

10. Kit according to claim 9, wherein the at least one pin comprises at least a threaded portion such that the pin can be fastened to the wheel body by screwing.

11. Kit according to claim 9, wherein the wheel body comprises two webs forming, respectively, one and the other of the two main faces in the state in which they are assembled with one another, the pin being arranged so as to keep the two webs assembled with one another.

12. Kit according to claim 9 further comprising at least one tire including a substantially annular outer part and a bead projecting radially inward from the outer part, the bead being shaped as to be housed in a groove of a wheel body when the tire is mounted around said wheel body,
wherein at least one aperture is formed the bead and opens onto a lateral surface of the bead.

13. Method for manufacturing an agricultural implement according to claim 1, comprising:
injection molding the wheel body,
removing the wheel body from the mold,
placing the tire around the wheel body on at least a part of the circumference of the wheel body, the placing of the tire around the wheel body including the insertion of the bead into the peripheral groove,
inserting at least one pin from one of the main faces of the wheel body, through the wheel body, until it projects into the peripheral groove and penetrates at least partially into the bead so as to form a radial lock which locks the tire around the wheel body.
